(19) United States
(12) Patent Application Publication
(10) Pub. No.: US 2019/0125625 A1
(43) Pub. Date: May 2, 2019

(54) COVER STRUCTURE OF A WASHER PUMP

(71) Applicant: TSUNG-CHEN HUANG, Puxin Township (TW)

(72) Inventor: TSUNG-CHEN HUANG, Puxin Township (TW)

(21) Appl. No.: 15/796,827

(22) Filed: Oct. 29, 2017

(51) Int. Cl. A61H 33/00; F04B 19/06; B05B 1/34

(52) U.S. Cl. CPC A61H 33/6021; B05B 3/02; B05B 1/34; F04B 19/06

(57) ABSTRACT

A cover structure of a washer pump has a base and a cover. The base and the cover are removably assembled together, which improves effect of the spa machine.

### BACKGROUND OF THE INVENTION

### 1. Field of the Invention

The present invention relates to a water therapy structure, and more particularly to a cover structure of a washer pump.

### 2. Description of the Related Art

Currently, a water spa machine generates jets of water and bubbles to soothe and relieve muscles tension. Current, nozzle cap of the spa machines utilize a screw plug structure to combine with a water supply device. Since each person's strength is different, the nozzle cap can be tighten too tight or too lose, which results different issues such as cleaning issue or lack of effect of the spa.

Therefore, it is desirable to provide a cover structure for a washer pump to mitigate and/or obviate the aforementioned problems.

### SUMMARY OF INVENTION

An objective of present invention is to provide a cover structure for a washer pump which is capable of improving the above-mention problems.

In order to achieve the above mentioned objective, A cover structure of a washer pump comprising: a base and a cover, the base having at least two opposing engaging indentations, a side of each engaging indentation provided with an engaging wall higher than the engaging indentation; the cover having at least two opposing assembling slots corresponding to the at least two engaging indentations of the base; each assembling slot coupling with a pivoting member to assemble an engaging member; the engaging member having an aperture engaging with an elastic member at an end, the elastic member pushing against the assembling slot, and another end of the elastic member extending out of the assembling slot and provided with a hook.

With the above-mentioned structure, following benefits can be obtained: the base and the cover are removably assembled together, which improves effect of the spa machine.

Other objects, advantages, and novel features of invention will become more apparent from the following detailed description when taken in conjunction with the accompanying drawings.

### BRIEF DESCRIPTION OF DRAWINGS

FIG. 1 is a perspective drawing of a preferred embodiment according to the present invention.

FIG. 2 is an exploded view of preferred embodiment according to the present invention.

FIG. 3 is a top view of preferred embodiment according to the present invention.

FIG. 4 is a cross-sectional drawing and a local detail schematic drawing of the FIG. 3 along a line A-A.

FIG. 5 is a cross-sectional drawing of the FIG. 3 along a line B-B.

FIG. 6 is a schematic drawing of actual operation of the preferred embodiment according to the present invention.

FIG. 7 shows by pressing the two engaging members to remove the cover from the base according the present invention.

FIG. 8 shows the cover being removed from the base according the present invention.

### DETAILED DESCRIPTION OF PREFERRED EMBODIMENT

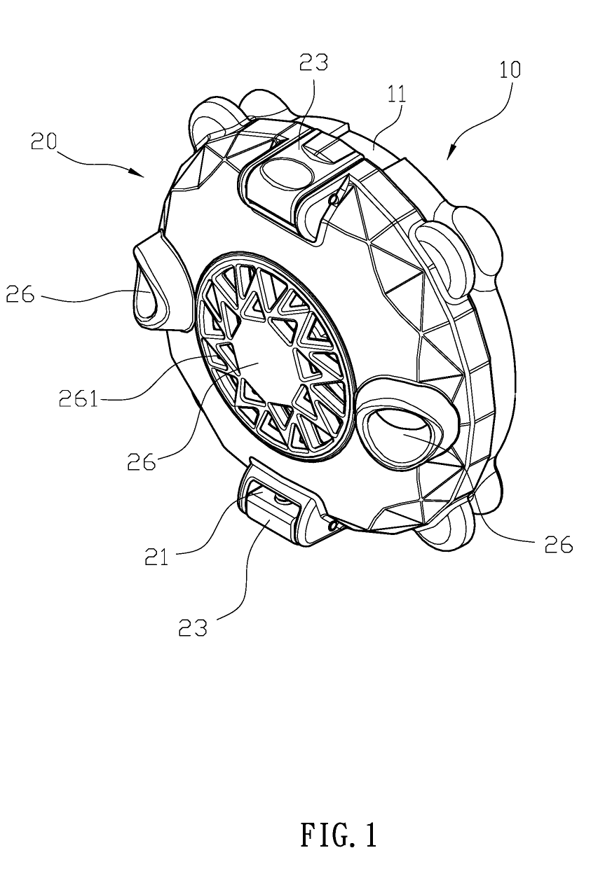

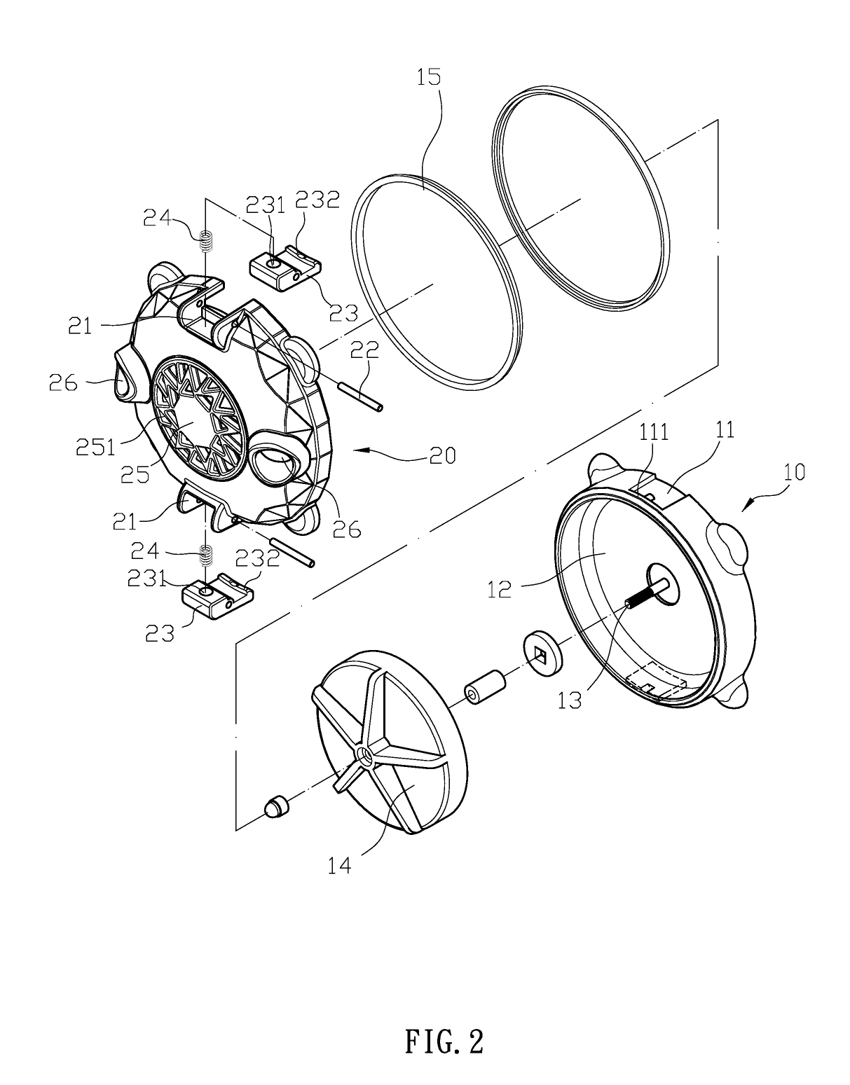

First, please refer to FIG. 1 and FIG. 2. A cover structure of a washer pump comprises: a base 10 and a cover 20. The base 10 has at least two opposing engaging indentations 11, and a side of each engaging indentation 11 is provided with an engaging wall 111 higher than the engaging indentation 11. The base 10 has a containment space 12, and the containment space 12 is provided with a driving shaft 13 configured for a driving a fan 14. The cover 20 has at least two opposing assembling slots 21 corresponding to the at least two engaging indentations 11 of the base 10. Each assembling slot 21 couples with a pivoting member 22 to assemble an engaging member 23. The engaging member 23 has an aperture 231 engaging with an elastic member 24 at an end, and the elastic member 24 pushes against the assembling slot 21. Furthermore, another end of the elastic member 24 extending out of the assembling slot 21 and is provided with a hook 232. Therefore, the engaging member 23 is pushed downward by the elastic member 24 and the hook 232 is engaged. In addition, the cover 20 is provided with a nozzle 25, an intake aperture 26 at each side of the nozzle 25 and a plurality of outlet apertures 251 disposed around the nozzle 25.

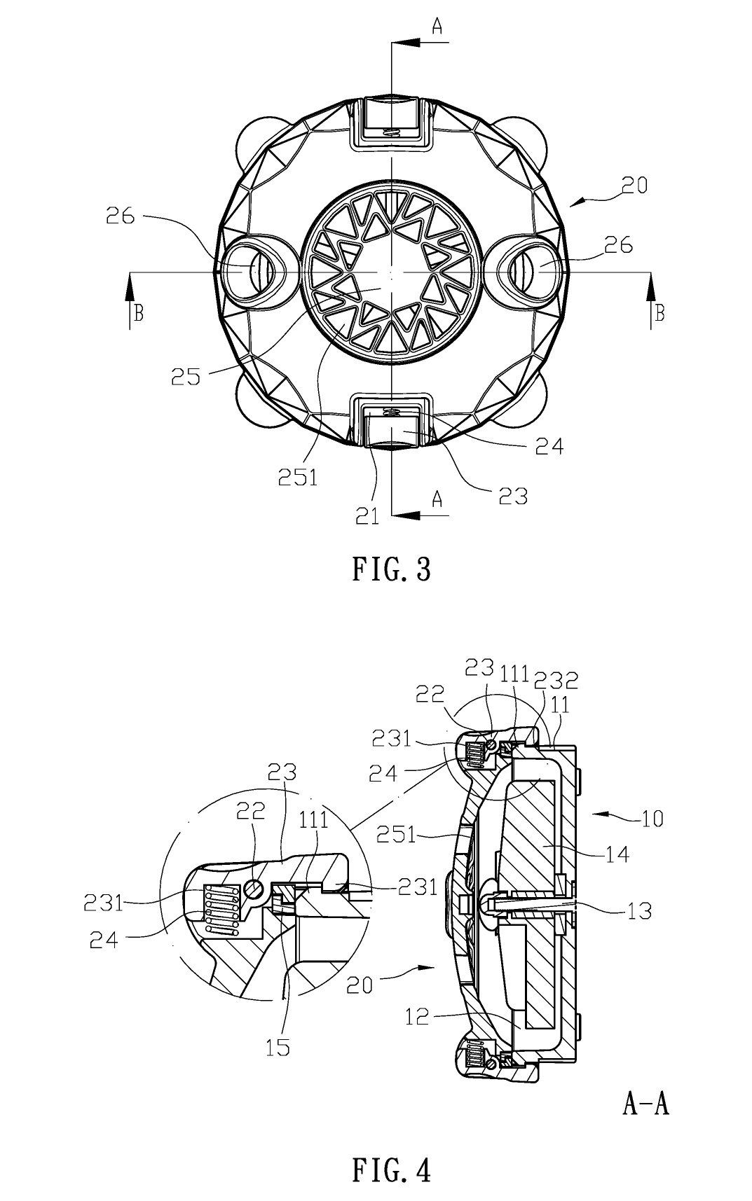

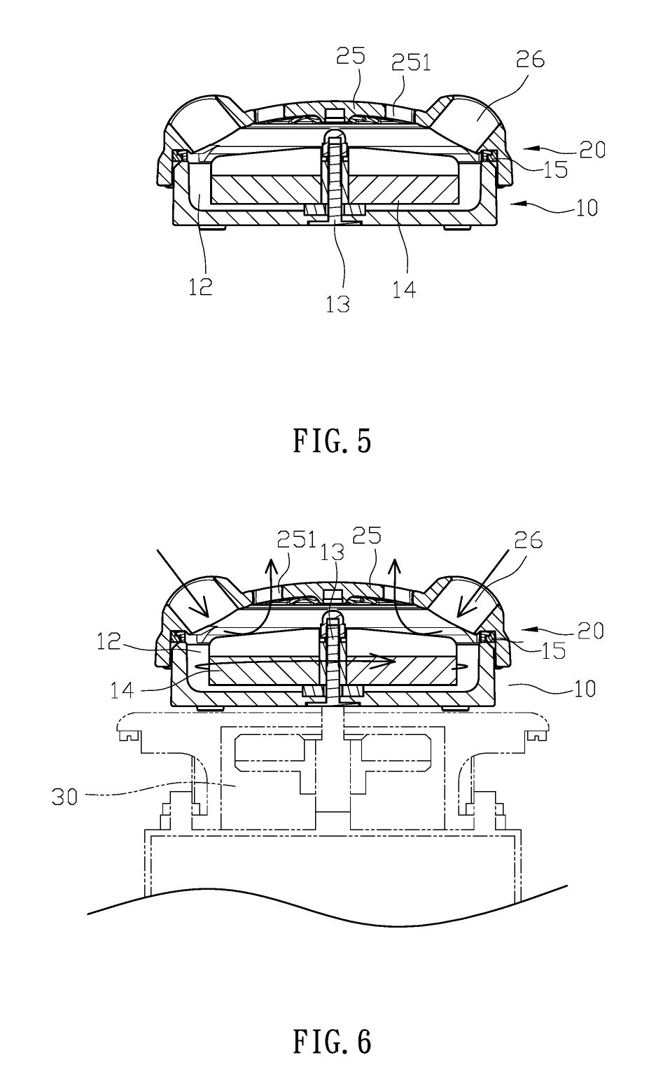

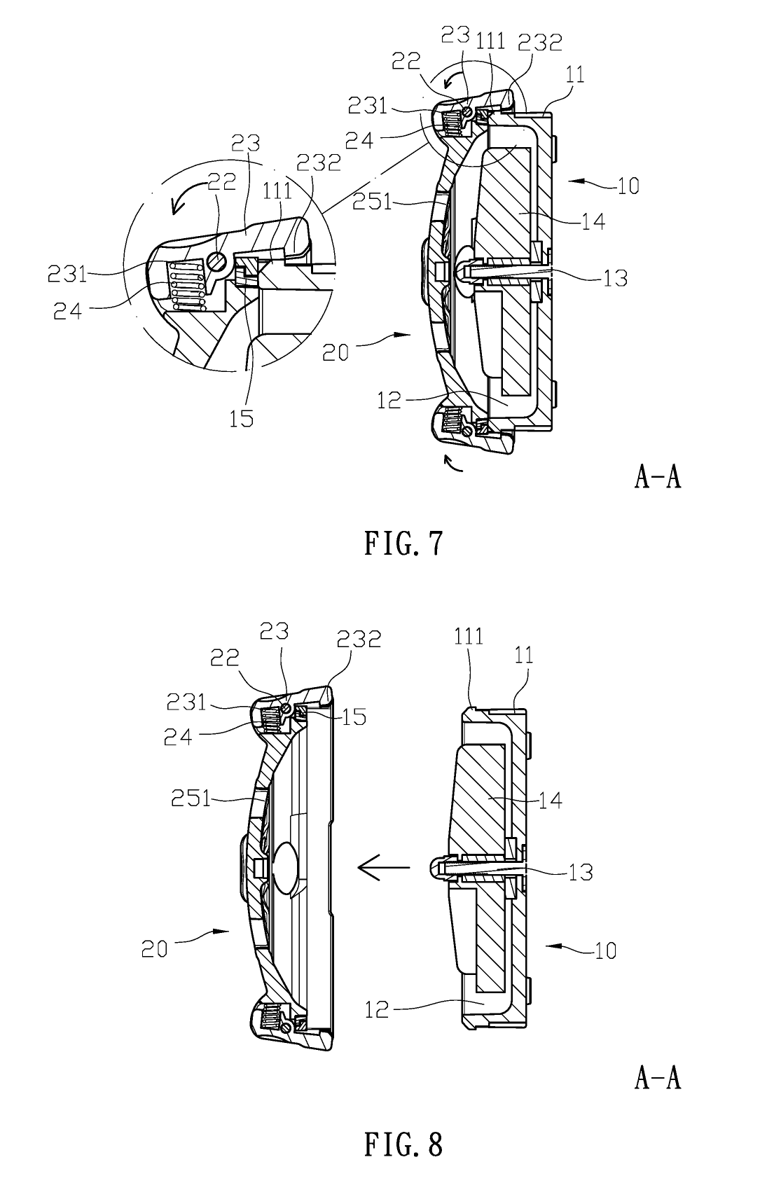

For assembly, please refer to FIGS. 2-5. The cover 20 covers the base 10, and two overlapped washers 15 are disposed between the base 10 and the cover 20. The two engaging members 23 correspondingly engages with the two engaging indentations 11 of the base 10. Since one end of each engaging member 23 has the elastic member 24, when the engaging member 23 passes through the engaging wall 111 of the engaging indentation 11 the elastic member 24 is compressed, then the elastic member 24 pushes the hook 232 of the engaging member 23 to engage with the engaging wall 111. Therefore, the cover 20 is securely engaged with the base 10 and contains the fan 14 in the containment space 12.

For actual operation, please refer to FIG. 6. The base 10 utilizes a driving motor 30 to rotate the driving shaft 13 to drive the fan 14, and the fan 14 generates a swirl due to a centrifugal force to move water from the two intake apertures 26 of the cover 20 into the containment space 12, then the water forms a stream at the center of the fan and leaves from the nozzle 25 to exit the outlet apertures 251 with air bubbles which can be therapeutical.

Moreover, in order to clean or maintain the cover 20, by pressing the two engaging member 23 of the cover 20 to compress the elastic member 24 on one end the engaging member 23 so the hook 232 on the another end of the engaging member 23 disengages from the engaging wall 111. Reversely, the engaging member 23 can engage with the base 10 again by the elastic member 24 ejects to push the hook 232.

With the above-mentioned structure, following benefits can be obtained: the base 10 and the cover 20 are removably assembled together, which improves effect of the spa machine.

Although the present invention has been explained in relation to its preferred embodiment, it is to be understood that many other possible modifications and variations can be made without departing from the spirit and scope of invention as hereinafter claimed.

What is claimed is:

1. A pump comprising:
a base; and
a cover for covering the base;
wherein:
the base has at least two opposing engaging indentations, a side of each engaging indentation provided with an engaging wall higher than the engaging indentation;
the cover has at least two opposing assembling slots corresponding to the at least two engaging indentations of the base, each assembling slot comprising a pivoting member to pivotably couple with an engaging member, a width of each assembling slot corresponding to a width of the respective engaging member;
each engaging member has an aperture on one end for accepting an elastic member, the elastic member pushing against the assembling slot to bias the engaging member, and an opposite end of the engaging member extends from the assembling slot and comprises a hook for engaging with the engaging wall of one of the engaging indentations, a width of each engaging indentation corresponding to a width of the hook of the respective engaging member; and
two overlapping washers disposed between the base and the cover.

2. The pump as claimed in claim 1, wherein the base has a containment space, and the containment space is provided with a driving shaft configured to drive an impeller.

3. The pump as claimed in claim 2, wherein the base further includes a driving motor for driving the driving shaft.

4. The pump as claimed in claim 1, wherein the cover is provided with a nozzle and intake apertures on opposite sides of the nozzle.

5. The pump as claimed in claim 4, wherein the nozzle of the cover is further provided with a plurality of outlet apertures.
